(19) United States
(12) Patent Application Publication
(10) Pub. No.: US 2026/0292822 A1
(43) Pub. Date: Sep. 24, 2026

(54) METHOD AND APPARATUS FOR EARLY INDICATION OF DATA TRANSMISSION IN MOBILE COMMUNICATIONS

(71) Applicant: MEDIATEK INC., Hsinchu City (TW)

(72) Inventors: Yi-Ju LIAO, Hsinchu City (TW); Wei-De WU, Hsinchu City (TW); Yi-Chia LO, Hsinchu City (TW); Cheng-Hsun LI, Hsinchu City (TW)

(73) Assignee: MEDIATEK INC., Hsinchu City (TW)

(21) Appl. No.: 19/476,106

(22) PCT Filed: Nov. 1, 2024
(86) PCT No.: PCT/CN2024/129346

§ 371 Date: Oct. 16, 2025

Related U.S. Application Data
(60) Provisional application No. 63/595,783, filed on Nov. 3, 2023.

(51) Int. Cl. H04W 72/1273; H04W 72/232

(52) U.S. Cl. CPC H04W 72/1273; H04W 72/232

(57) ABSTRACT

Various solutions for early indication of data transmission with respect to an apparatus in mobile communications are described. The apparatus may receive a downlink control information (DCI) indicating one or more data scheduling information associated with one or more carriers. Each of the one or more data scheduling information may include at least one of a carrier status and a data amount. The apparatus may receive data scheduled by a subsequent DCI on the one or more carriers based on the one or more data scheduling information.

### CROSS REFERENCE TO RELATED PATENT APPLICATION(S)

The present disclosure is part of a non-provisional application claiming the priority benefit of U.S. Patent Application No. 63/595,783, filed 3 Nov. 2023, the content of which herein being incorporated by reference in its entirety.

### TECHNICAL FIELD

The present disclosure is generally related to mobile communications and, more particularly, to early indication of data transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, power saving technologies have been developed. In particular, various features have been introduced to enhance power saving for both the network and the user equipment (UE) across multiple domains, including time, frequency, spatial, and power.

For example, features of discontinuous reception (DRX) assist reduce UE power consumption by allowing the device to periodically enter a sleep state, avoiding continuous monitoring of physical downlink control channel (PDCCH). More specifically, DRX has two modes: idle mode, for paging message monitoring, and connected mode, where the UE wakes up periodically to check for downlink/uplink data. DRX also benefits network efficiency by reducing unnecessary Channel state information (CSI) and sounding reference signal (SRS) transmissions during sleep periods, freeing resources for other UEs.

However, in some scenarios, the UE may process the scheduled data with fixed UE capability, regardless of the size of the scheduled data, which may lead to unnecessary power consumption.

Accordingly, how to provide a dynamic power saving procedure becomes an important issue in the newly developed wireless communication network. Therefore, there is a need to provide proper schemes to provide a dynamic power saving procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to early indication of data transmission with respect to apparatus in mobile communications.

In one aspect, a method may involve an apparatus receiving a downlink control information (DCI) indicating one or more data scheduling information associated with one or more carriers. Each of the one or more data scheduling information may include at least one of a carrier status and a data amount. The method may further involve the apparatus receiving data scheduled by a subsequent DCI on the one or more carriers based on the one or more data scheduling information.

In one aspect, a method may involve an apparatus transmitting a DCI indicating one or more data scheduling information associated with one or more carriers. Each of the one or more data scheduling information may include at least one of a carrier status and a data amount. The method may further involve the apparatus transmitting data scheduled by a subsequent DCI on the one or more carriers based on the one or more data scheduling information.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, by the transceiver, a DCI indicating one or more data scheduling information associated with one or more carriers. Each of the one or more data scheduling information may include at least one of a carrier status and a data amount. The processor may further perform operations comprising receiving, via the transceiver, data scheduled by a subsequent DCI on the one or more carriers based on the one or more data scheduling information.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to early indication of data transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a downlink control information (DCI) to a user equipment (UE). The DCI may indicate one or more data scheduling information associated with one or more carriers. Each of the one or more data scheduling information may include at least one of a carrier status and a data amount.

After receiving the DCI, the UE may receive: (1) a subsequent DCI; and (2) data scheduled by the subsequent DCI on the one or more carriers based on the one or more data scheduling information. More specifically, the one or more data scheduling information may include information of upcoming data scheduled by the subsequent DCI on the one or more carriers. Therefore, based on the one or more data scheduling information pre-indicated for upcoming data (i.e., the data scheduled by the subsequent DCI), the UE may adjust UE capability in advance before receiving the data scheduled by the subsequent DCI to achieve flexible power saving goals. The subsequent DCI may be another DCI after/later than the DCI indicating the one or more data scheduling information.

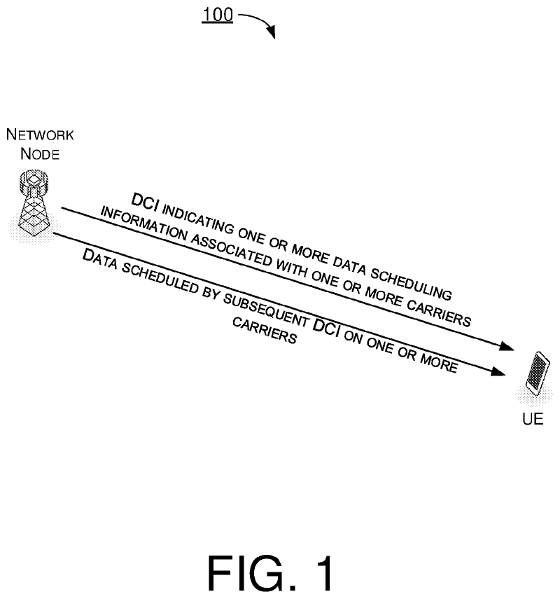

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a DCI to the UE. The DCI may indicate one or more data scheduling information associated with one or more carriers. Each of the one or more data scheduling information may include at least one of a carrier status and a data amount. More specifically, the data scheduling information may be used as an early indication of data transmission, particularly for impending data.

After receiving the DCI, the UE may receive: (1) a subsequent DCI (i.e., another DCI transmitted later than the DCI); and (2) data scheduled by the subsequent DCI on the one or more carriers based on the one or more data scheduling information. More specifically, the one or more data scheduling information may include information of impending data scheduled by the subsequent DCI on the one or more carriers. Therefore, based on the one or more data scheduling information pre-indicated for upcoming data (i.e., the data scheduled by the subsequent DCI), the UE may proactively determine and apply a signal processing capability to receive the impending data in advance, aiming to achieve flexible power saving purposes.

In some implementations, the UE may determine a signal processing capability based on a maximum bandwidth associated with the carrier status. In particular, each of the one or more data scheduling information may include the carrier status of corresponding carrier. In some cases, the carrier status may include scheduled status (i.e., ON status or enabled status) of corresponding carrier for the UE. In some cases, the carrier status may include non-scheduled status (i.e., OFF status or disable status) of corresponding carrier for the UE. Accordingly, based on the carrier status(es), the UE may determine the number of scheduled (i.e., active) carrier(s) for transmitting data, and the UE may determine the maximum bandwidth (i.e., total possible bandwidth) of the carrier(s) with scheduled status.

Then, the UE may determine and apply the signal processing capability based on the maximum bandwidth. In some cases, when the maximum bandwidth is high (i.e., possible high data throughput), the UE may raise and apply the signal processing capability (e.g., CPU clock or voltage) for receiving the impending data. In some cases, when the maximum bandwidth is low (i.e., possible low data throughput), the UE may lower and apply the signal processing capability (e.g., CPU clock or voltage) for receiving the impending data.

In some implementations, the UE may determine a signal processing capability based on a total data amount associated with the data amount. In particular, each of the one or more data scheduling information may include the data amount of corresponding carrier. In some cases, the data amount may include a level of physical resource block (PRB) utilization. In some cases, the data amount may include a number of PRB. Accordingly, based on the data amount(s), the UE may determine the level/number of PRB of data, and the UE may determine the total data amount of data to be transmitted on the carrier(s).

Then, the UE may determine and apply the signal processing capability based on the total data amount. In some cases, when the total data amount is large (i.e., possible high data throughput), the UE may raise and apply the signal processing capability (e.g., CPU clock or voltage) for receiving the impending data. In some cases, when the total data amount is small (i.e., possible low data throughput), the UE may lower and apply the signal processing capability (e.g., CPU clock or voltage) for receiving the impending data.

In some implementations, the DCI in a first slot may indicate the one or more data scheduling information associated with the one or more carriers, and the subsequent DCI may schedule the data in a second slot. For example, the DCI in slot N indicates the one or more data scheduling information associated with the one or more carriers, and the subsequent DCI schedules the data in slot N+ a while a is natural number.

In some implementations, the DCI may include a scheduling DCI including information to schedule downlink or uplink data transmission. For example, the scheduling DCI includes DCI with format 1_0, 1_1, 1_2, 1_3, 0_0 or 0_1. In some implementations, the DCI may include a non-scheduling DCI including control information without information scheduling downlink or uplink data transmission. For example, the non-scheduling DCI includes DCI with format 2_0, 2_1, 2_2 or 2_3.

In some implementations, each of the DCI and the subsequent DCI may include a single DCI or a two-stage DCI. In some cases, the two-stage DCI may include a first stage DCI and a second stage DCI while the first stage DCI includes scheduling information regarding the second stage DCI, and the second stage DCI includes scheduling information for one or multiple physical downlink shared channel (PDSCH) and/or physical uplink shared channel (PUSCH) in scheduled carrier(s)/cell(s).

In some cases, in an event that each of the DCI and the subsequent DCI includes the two-stage DCI, the first stage DCI of the DCI in a first slot may indicate the one or more data scheduling information associated with the one or more carriers, and the second stage DCI of the subsequent DCI may schedule the data in a second slot. For example, the first stage of the DCI in slot N indicates the one or more data scheduling information associated with the one or more carriers, and the second stage DCI of the subsequent DCI schedules the data in slot N+ a while a is natural number.

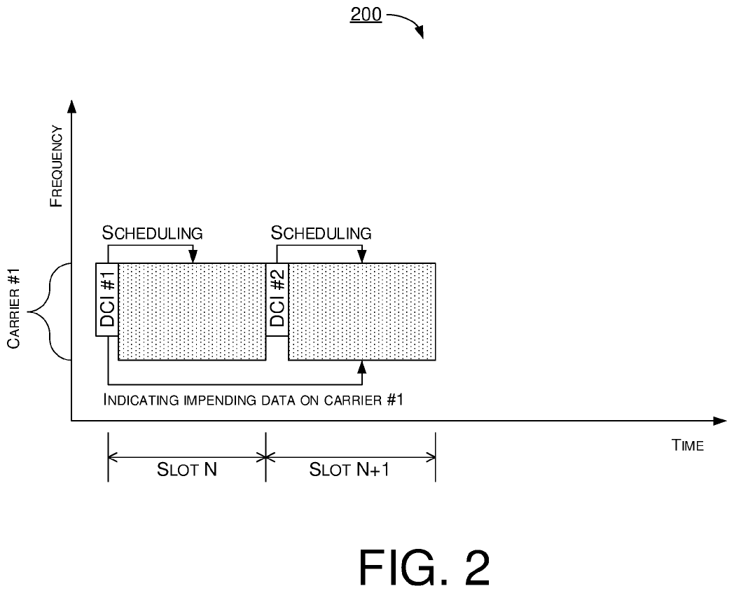

FIG. 2 illustrates an example scenario 200 under schemes in accordance with implementations of the present disclosure. For example, the network node transmits DCI #1 to the UE in slot N. DCI #1 (1) schedules data and (2) indicates data scheduling information associated with carrier #1. More specifically, the data scheduling information includes a carrier status which is “ON”, and the data scheduling information is used to indicate that impending data is going to be transmitted on carrier #1 in later slot (e.g., slot N+1).

After receiving DCI #1, the UE may receive: (1) DCI #2 in slot N+1; and (2) data scheduled by DCI #2 on carrier #1 based on the data scheduling information. In this example, based on the data scheduling information pre-indicated for impending data (i.e., the data scheduled by DCI #2), the UE proactively determines and applies signal processing capability (e.g., CPU clock or voltage) before receiving the impending data in advance, aiming to achieve flexible power saving purposes.

In some scenarios, the UE determines a maximum bandwidth of carrier #1 having carrier status “ON” in slot N+1, and then determines and applies the signal processing capability based on the maximum bandwidth. In some scenarios, when the data scheduling information includes data amount associated with carrier #1 in slot N+1, the UE determines a total data amount of data amount of carrier #1 in slot N+1, and then determines and applies the signal processing capability based on the total data amount of data.

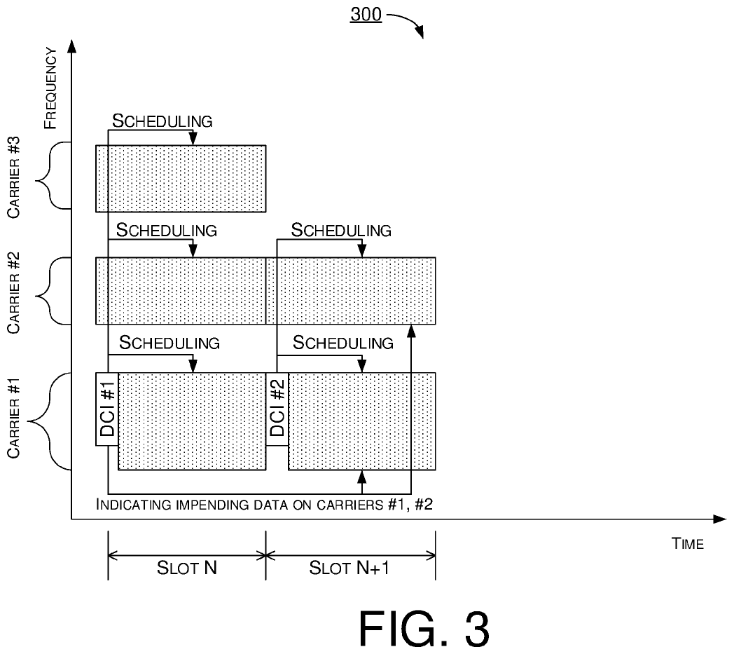

FIG. 3 illustrates an example scenario 300 under schemes in accordance with implementations of the present disclosure. For example, the network node transmits DCI #1 to the UE in slot N. DCI #1 (1) schedules data and (2) indicates data scheduling information associated with carriers #1 to #3. More specifically, each data scheduling information includes a carrier status which is “ON” or “OFF”, and the data scheduling information are used to indicate whether the impending data is going to be transmitted on carriers #1 to #3 in later slot (e.g., slot N+1). The data scheduling information includes: (1) a carrier status which is “ON” for carrier #1; (2) a carrier status which is “ON” for carrier #2; and (3) a carrier status which is “OFF” for carrier #3. In other words, the data scheduling information are used to indicate that impending data is going to be transmitted in slot N+1 on carrier #1 and carrier #2, but not on carrier #3.

After receiving DCI #1, the UE may receive: (1) DCI #2 in slot N+1; and (2) data scheduled by DCI #2 on carrier #1 and carrier #2 based on the data scheduling information. In this example, based on the data scheduling information pre-indicated for impending data (i.e., the data scheduled by DCI #2), the UE proactively determines and applies signal processing capability (e.g., CPU clock or voltage) before receiving the impending data in advance, aiming to achieve flexible power saving purposes.

In some scenarios, the UE determines a maximum bandwidth of carriers #1 and #2 having carrier status “ON” in slot N+1, and then determines and applies the signal processing capability based on the maximum bandwidth. In some scenarios, when the data scheduling information includes data amounts associated with carriers #1 and #2 in slot N+1, the UE determines a total data amount of data amounts of carriers #1 and #2 in slot N+1, and then determines and applies the signal processing capability based on the total data amount of data.

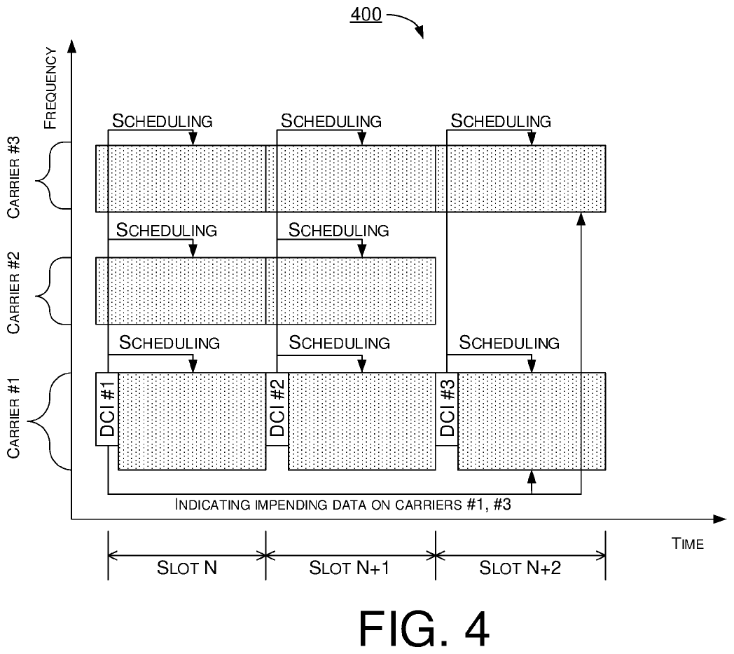

FIG. 4 illustrates an example scenario 400 under schemes in accordance with implementations of the present disclosure. For example, the network node transmits DCI #1 to the UE in slot N. DCI #1 (1) schedules data and (2) indicates data scheduling information associated with carriers #1 to #3. More specifically, each data scheduling information includes a carrier status which is “ON” or “OFF”, and the data scheduling information are used to indicate whether the impending data is going to be transmitted on carriers #1 to #3 in later slot (e.g., slot N+2). The data scheduling information includes: (1) a carrier status which is “ON” for carrier #1; (2) a carrier status which is “OFF” for carrier #2; and (3) a carrier status which is “ON for carrier #3. In other words, the data scheduling information is used to indicate that impending data is going to be transmitted in slot N+2 on carrier #1 and carrier #3, but not on carrier #2.

After receiving DCI #1, the UE may receive: (1) DCI #2 in slot N+1; (2) data scheduled by DCI #2 on carriers #1 to #3; (3) DCI #3 in slot N+2; and (3) data scheduled by DCI #3 on carrier #1 and carrier #3 based on the data scheduling information. In this example, based on the data scheduling information pre-indicated for impending data (i.e., the data scheduled by DCI #3), the UE proactively determines and applies signal processing capability (e.g., CPU clock or voltage) before receiving the impending data in advance, aiming to achieve flexible power saving purposes.

In some scenarios, the UE determines a maximum bandwidth of carriers #1 and #3 having carrier status “ON” in slot N+2, and then determines and applies the signal processing capability based on the maximum bandwidth. In some scenarios, when the data scheduling information includes data amounts associated with carriers #1 and #3 in slot N+2, the UE determines a total data amount of data amounts of carriers #1 and #3 in slot N+2, and then determines and applies the signal processing capability based on the total data amount of data.

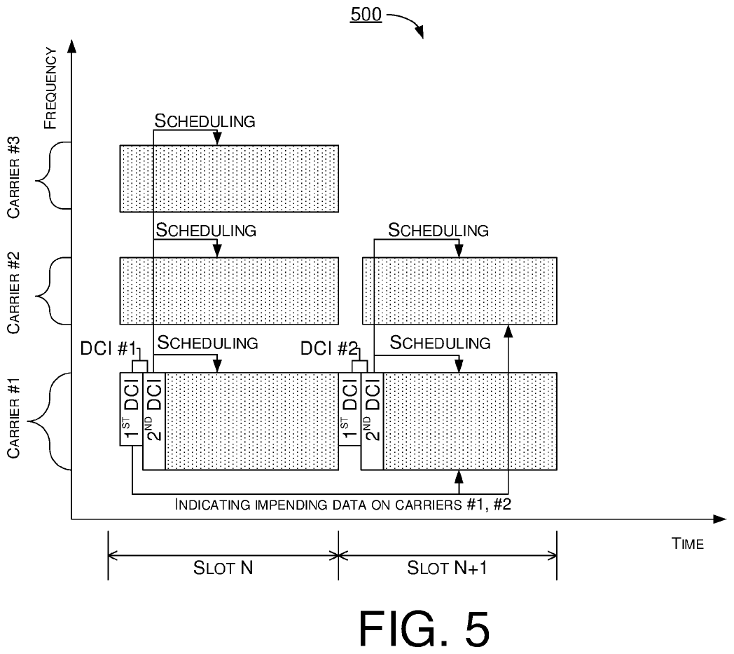

FIG. 5 illustrates an example scenario 500 under schemes in accordance with implementations of the present disclosure. For example, the network node transmits two-stage DCI #1 to the UE in slot N. A first stage DCI of DCI #1 indicates (1) a second stage DCI scheduling data and (2) data scheduling information associated carriers #1 to #3. More specifically, each data scheduling information includes a carrier status which is “ON” or “OFF”, and the data scheduling information are used to indicate whether the impending data is going to be transmitted on carriers #1 to #3 in later slot (e.g., slot N+1). The data scheduling information includes: (1) a carrier status which is “ON” for carrier #1; (2) a carrier status which is “ON” for carrier #2; and (3) a carrier status which is “OFF” for carrier #3. In other words, the data scheduling information are used to indicate that impending data is going to be transmitted in slot N+1 on carrier #1 and carrier #2, but not on carrier #3.

After receiving DCI #1, the UE may receive: (1) two-stage DCI #2 in slot N+1; and (2) data scheduled by a second stage DCI of DCI #2 on carrier #1 and carrier #2 based on the data scheduling information. In this example, based on the data scheduling information pre-indicated for impending data (i.e., the data scheduled by the second stage DCI of DCI #2), the UE proactively determines and applies signal processing capability (e.g., CPU clock or voltage) before receiving the impending data in advance, aiming to achieve flexible power saving purposes.

In some scenarios, the UE determines a maximum bandwidth of carriers #1 and #2 having carrier status “ON” in slot N+1, and then determines and applies the signal processing capability based on the maximum bandwidth. In some scenarios, when the data scheduling information includes data amounts associated with carriers #1 and #2 in slot N+1, the UE determines a total data amount of data amounts of carriers #1 and #2 in slot N+1, and then determines and applies the signal processing capability based on the total data amount of data.

### Illustrative Implementations

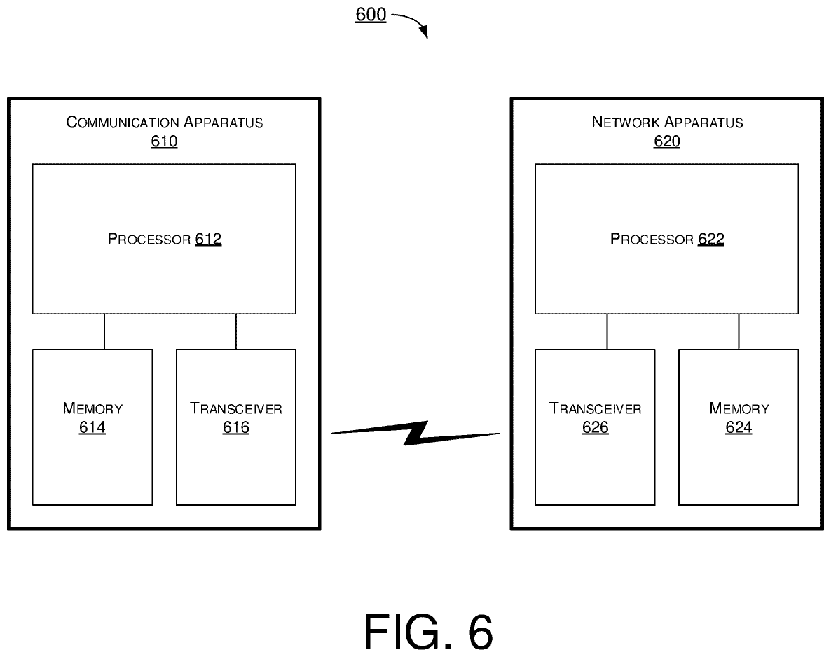

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to early indication of data transmission with respect to UE and network apparatus in mobile communications, including scenarios/schemes described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including early indication of data transmission in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In other words, processor 612 may transceive the data such as configuration, message, signal, information, indicator, etc. via transceiver 616. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In other words, processor 622 may transceive the data such as configuration, message, signal, information, indicator, etc. via transceiver 626. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

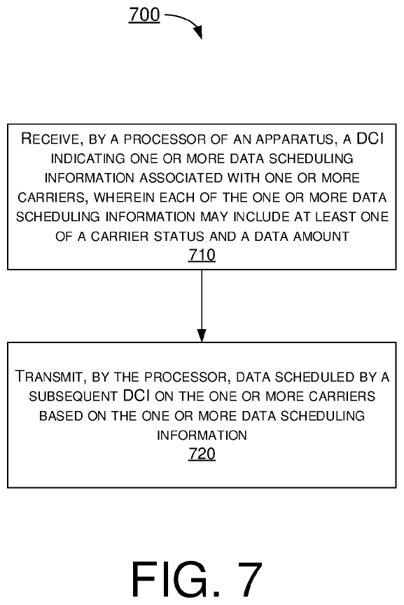

FIG. 7 illustrates an example process 700 in accordance with an implementation of the present disclosure. £ Process 700 may be an example implementation of above scenarios/schemes, whether partially or completely, with respect to early indication of data transmission of the present disclosure. Process 700 may represent an aspect of implementation of features of communication apparatus 610. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of communication apparatus 610 receiving a DCI indicating one or more data scheduling information associated with one or more carriers. Each of the one or more data scheduling information may include at least one of a carrier status and a data amount. Process 700 may proceed from block 710 to block 720.

At block 720, process 700 may involve processor 612 of communication apparatus 610 receiving data scheduled by a subsequent DCI on the one or more carriers based on the one or more data scheduling information.

In some implementations, process 700 involve processor 612 of communication apparatus 610 determining a signal processing capability based on a maximum bandwidth associated with the carrier status. Process 700 involve processor 612 of communication apparatus 610 applying the signal processing capability.

In some implementations, process 700 involve processor 612 of communication apparatus 610 determining a signal processing capability based on a total data amount associated with the data amount. Process 700 involve processor 612 of communication apparatus 610 applying the signal processing capability.

In some implementations, the DCI in a first slot may indicate the one or more data scheduling information associated with the one or more carriers, and the subsequent DCI may schedule the data in a second slot.

In some implementations, the DCI may include a scheduling DCI or a non-scheduling DCI.

In some implementations, each of the DCI and the subsequent DCI may include a single DCI or a two-stage DCI.

In some implementations, in an event that each of the DCI and the subsequent DCI includes the two-stage DCI, a first stage DCI of the DCI in a first slot may indicate the one or more data scheduling information associated with the one or more carriers, and a second stage DCI of the subsequent DCI may schedule the data in a second slot.

In some implementations, the carrier status may include scheduled status or non-scheduled status, and the data amount may include a level of PRB utilization.

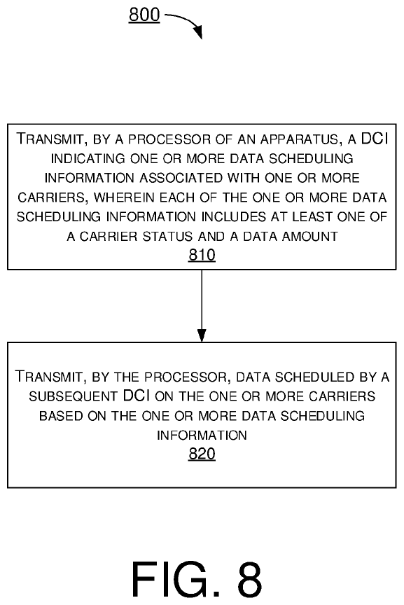

FIG. 8 illustrates an example process 800 in accordance with an implementation of the present disclosure. Process 800 may be an example implementation of above scenarios/schemes, whether partially or completely, with respect to early indication of data transmission of the present disclosure. Process 800 may represent an aspect of implementation of features of network apparatus 620. Process 800 may include one or more operations, actions, or functions as illustrated by one or more of blocks 810 to 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 620 or any suitable network device or machine type devices. Solely for illustrative purposes and without limitation, process 800 is described below in the context of network apparatus 620. Process 800 may begin at block 810.

At block 810, process 800 may involve processor 622 of network apparatus 620 transmitting a DCI indicating one or more data scheduling information associated with one or more carriers. Each of the one or more data scheduling information may include at least one of a carrier status and a data amount. Process 800 may proceed from block 810 to block 820.

At block 820, process 800 may involve processor 622 of network apparatus 620 transmitting data scheduled by a subsequent DCI on the one or more carriers based on the one or more data scheduling information.

In some implementations, the DCI in a first slot may indicate the one or more data scheduling information associated with the one or more carriers, and the subsequent DCI may schedule the data in a second slot.

In some implementations, the DCI may include a scheduling DCI or a non-scheduling DCI.

In some implementations, each of the DCI and the subsequent DCI may include a single DCI or a two-stage DCI.

In some implementations, in an event that each of the DCI and the subsequent DCI includes the two-stage DCI, a first stage DCI of the DCI in a first slot may indicate the one or more data scheduling information associated with the one or more carriers, and a second stage DCI of the subsequent DCI may schedule the data in a second slot.

In some implementations, the carrier status may include scheduled status or non-scheduled status, and the data amount may include a level of PRB utilization.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) indicating one or more data scheduling information associated with one or more carriers, wherein each of the one or more data scheduling information includes at least one of a carrier status and a data amount; and
receiving, by the processor, data scheduled by a subsequent DCI on the one or more carriers based on the one or more data scheduling information.

2. The method of claim 1, further comprising:
determining, by the processor, a signal processing capability based on a maximum bandwidth associated with the carrier status; and
applying, by the processor, the signal processing capability.

3. The method of claim 1, further comprising:
determining, by the processor, a signal processing capability based on a total data amount associated with the data amount; and
applying, by the processor, the signal processing capability.

4. The method of claim 1, wherein the DCI in a first slot indicates the one or more data scheduling information associated with the one or more carriers, and wherein the subsequent DCI schedules the data in a second slot.

5. The method of claim 1, wherein the DCI includes a scheduling DCI or a non-scheduling DCI.

6. The method of claim 1, wherein each of the DCI and the subsequent DCI includes a single DCI or a two-stage DCI.

7. The method of claim 6, wherein in an event that each of the DCI and the subsequent DCI includes the two-stage DCI, a first stage DCI of the DCI in a first slot indicates the one or more data scheduling information associated with the one or more carriers, and a second stage DCI of the subsequent DCI schedules the data in a second slot.

8. The method of claim 1, wherein the carrier status includes scheduled status or non-scheduled status, and wherein the data amount includes a level of physical resource block (PRB) utilization.

9. A method, comprising:
transmitting, by a processor of an apparatus, a downlink control information (DCI) indicating one or more data scheduling information associated with one or more carriers, wherein each of the one or more data scheduling information includes at least one of a carrier status and a data amount; and
transmitting, by the processor, data scheduled by a subsequent DCI on the one or more carriers based on the one or more data scheduling information.

10. The method of claim 9, wherein the DCI in a first slot indicates the one or more data scheduling information associated with the one or more carriers, and wherein the subsequent DCI schedules the data in a second slot.

11. The method of claim 9, wherein the DCI includes a scheduling DCI or a non-scheduling DCI.

12. The method of claim 9, wherein the DCI includes a single DCI or a two-stage DCI.

13. The method of claim 12, wherein in an event that each of the DCI and the subsequent DCI includes the two-stage DCI, a first stage DCI of the DCI in a first slot indicates the one or more data scheduling information associated with the one or more carriers, and a second stage DCI of the subsequent DCI schedules the data in a second slot.

14. The method of claim 9, wherein the carrier status includes scheduled status or non-scheduled status, and wherein the data amount includes a level of physical resource block (PRB) utilization.

15. An apparatus, comprising:
a transceiver which, during operation, wirelessly communicates with a wireless network; and
a processor communicatively coupled to the transceiver such that, during operation, the processor performs operations comprising:
receiving, via the transceiver, a downlink control information (DCI) indicating one or more data scheduling information associated with one or more carriers, wherein each of the one or more data scheduling information includes at least one of a carrier status and a data amount; and
receiving, via the transceiver, data scheduled by a subsequent DCI on the one or more carriers based on the one or more data scheduling information.

16. The apparatus of claim 15, wherein, during operation, the processor further performs operations comprising:
determining a signal processing capability based on a maximum bandwidth associated with the carrier status; and
applying the signal processing capability.

17. The apparatus of claim 15, wherein, during operation, the processor further performs operations comprising:
determining a signal processing capability based on a total data amount associated with the data amount; and
applying the signal processing capability.

18. The apparatus of claim 15, wherein the DCI includes a scheduling DCI or a non-scheduling DCI.

19. The apparatus of claim 15, wherein the DCI includes a single DCI or a two-stage DCI.

20. The apparatus of claim 19, wherein in an event that each of the DCI and the subsequent DCI includes the two-stage DCI, a first stage DCI of the DCI in a first slot indicates the one or more data scheduling information associated with the one or more carriers, and a second stage DCI of the subsequent DCI schedules the data in a second slot.
